(19) United States
(12) Patent Application Publication
(10) Pub. No.: US 2011/0101016 A1
(43) Pub. Date: May 5, 2011

(54) LOW VISION PATIENT COMPLIANT MEDICATION MANAGEMENT SYSTEM AND METHOD

(75) Inventor: Robert A. Luciano, JR., Reno, NV (US)

(73) Assignee: Edge Medical Properties, LLC, Reno, NV (US)

(21) Appl. No.: 12/891,042

(22) Filed: Sep. 27, 2010

Related U.S. Application Data
(60) Provisional application No. 61/245,912, filed on Sep. 25, 2009.

(51) Int. Cl. B65D 83/04; B65G 59/00

(52) U.S. Cl. 221/1; 221/8; 221/3

(57) ABSTRACT

A compliance packaging system and method for dispensing tablets to the vision impaired is described. The compliance packaging system comprises a dispenser and compliance indicia. The dispenser has a plurality of tablet containers wherein each of the tablet containers contains at least one tablet associated with a dosage regimen. The compliance indicia are associated with the plurality of tablet containers and are configured to allow a visually impaired person to verify that a particular tablet container has exited the dispenser.

### CROSS-REFERENCE TO RELATED PATENT APPLICATIONS

The present patent application claims the priority of provisional patent application No. 61/245,912, filed Sep. 25, 2009. The present patent application is also a continuation-in-part of patent application Ser. No. ______

### FIELD OF THE INVENTION

This invention relates to a compliance packaging system and method for the vision impaired. More particularly, the compliance packaging system and method provides a tablet management system with compliance indicia that allow the vision impaired to determine whether a tablet in a dosage regimen has been consumed.

### BACKGROUND

One of the major problems in taking daily medications, including prescription medications, non-prescription medications and nutraceuticals emanates from patients having to take more than one medication in the form of tablets. A principal concern is determining whether all medications are in compliance with the prescribed/recommended daily regimen. Many times this concern is compounded by the requirement that portions of the different medications must be taken at different times during the day.

The fear of taking improper dosages of prescribed medication can be particularly acute in the elderly, many of whom have some degree of mental dementia and can easily be confused as to whether they have taken all of their medications at the correct time. Some patients have difficulty sorting out the medications prior to taking them and taking the medication in a timely manner.

A further complication of patient adherence to multiple medication regimens is that many patients have difficulty with eyesight, suffering from reduced vision or even complete blindness. These patients may be unable to access information regarding their own medications because they are not able to read standard text. For these reasons, such patients may have a difficult time complying with a medication regimen. Providing medications to disabled or incapacitated individuals can also be complicated because one caregiver may oversee the medication of many patients.

Solid dose medicines are typically sold in vials, with each specific medicine type and dosage in a separate vial. When multiple medications are required to be taken at the same time, typically a patient will be required to extract the proper medicine from each vial. After the medicine is taken from the vial, there is no way to easily determine that it was actually taken. Also, typically the patient (or caregiver) is responsible for determining the proper medicine to take at the proper time. This can be particularly confusing when medicines or medicine groups need to be administered on an irregular schedule (i.e. once a week, every other day, etc.). One solution to the problem of taking multiple medications is to pre-package the multiple medications so that users can take the pre-packaged medications at a predetermined time.

There are compartmentalized sealed cups available commercially to assist patients and/or health care providers with this process. These, however, require the patient or caregiver to presort all medicines and to load them into their proper dosage period compartment, typically on weekly basis. This is time consuming and subject to human error. There are also some products that are commercially available or are available through institutionalized groups or hospitals that contain the presorted medicines in individual pouches. The individual pouches can be pre-labeled/printed with the proper time and date. However, there remains a need for compliance packaging that makes the dosage consumption time accessible to a person with limited or no vision.

### SUMMARY

A compliance packaging system and method for dispensing tablets to the vision impaired is described. The compliance packaging system comprises a dispenser and compliance indicia. The dispenser has a plurality of tablet containers wherein each of the tablet containers contains at least one tablet associated with a dosage regimen. The compliance indicia are associated with the plurality of tablet containers and are configured to verify that a particular tablet container has exited the dispenser.

In another embodiment, the compliance packaging system comprises a dispenser, a drive element and compliance indicia. The dispenser has a plurality of tablet containers wherein each of the tablet containers contains at least one tablet associated with a dosage regimen. The dispenser also includes an aperture configured to allow the tablet containers to exit the dispenser through the aperture. The drive element is mounted on the dispenser and is configured to advance the tablet containers toward the aperture. Each of the compliance indicia are associated with a tablet container and are configured to verify that a particular tablet container has exited the dispenser through the aperture.

A method for dispensing tablets to the vision impaired comprises housing a plurality of tablet containers in a dispenser, in which each of the tablet containers contains at least one tablet associated with a dosage regimen. The method further comprises actuating a drive element to advance the tablet containers such that the tablet containers exit the dispenser. A compliance indicator indicates that a particular tablet container has exited the dispenser.

### DRAWINGS

The present invention will be more fully understood by reference to the following drawings which are for illustrative, not limiting, purposes.

FIG. 1 is a perspective view of one embodiment of a spiral packaging system.

FIG. 2 is an exploded view of the spiral packaging system of FIG. 1.

FIG. 3 is a perspective view of the spiral packaging system of FIGS. 1 and 2 shown without the second shell portion and showing a plurality of containers.

FIG. 4 is a perspective view of one embodiment of a spiral packaging system shown with a medicament container.

FIG. 5 is another perspective view of the spiral packaging system of FIG. 4 shown without the medicament container.

FIG. 6 is a perspective view of a housing portion of the spiral packaging system of FIG. 5.

FIG. 7 is a perspective view of the spiral packaging system of FIG. 1 through FIG. 3 shown with a compliance wheel to provide a patient medication management system.

FIG. 8 is an exploded view of the patient medication management system of FIG. 7 shown with the compliance wheel removed.

FIG. 9 is a perspective view of another embodiment of a patient medication management system.

FIG. 10 is a perspective view of the patient medication management system of FIG. 9 shown with the compliance wheel removed and with the internal shell components omitted for clarity.

FIG. 11 shows the second side of the housing of the patient medication management system of FIG. 10.

FIG. 12 shows the second side of the housing of the patient medication management system of FIG. 10.

FIGS. 13A-13F are plan views of an embodiment of a compliance wheel modified for low-vision patients.

FIGS. 14A and 14B are perspective views of one embodiment of a medicament container.

FIG. 15 is a perspective view of a compliance wheel interacting with a medicament container.

FIG. 16 is a perspective view of one embodiment of a patient medication management system shown with a portion of the housing removed to illustrate interaction of a compliance wheel with a plurality of medicament containers.

FIG. 17 is a perspective view of a portion of a strip of medicament containers showing how one embodiment of audio compliance indicia is actuated.

FIG. 18 is a perspective view of one embodiment of spiral packaging system in a resting position.

FIGS. 19A-19E show a label strip usable with the patient medication management system.

FIG. 20 shows a perspective view of one embodiment of the spiral packaging system that includes Braille and audio indicia and precaution information.

FIGS. 21A-21C show perspective views of another embodiment of the spiral packaging system, including low-vision adaptive indicia.

FIG. 22 shows one set of illustrative symbols that can be used with the spiral packaging system as a form of low-vision adaptive precaution indicia.

FIG. 23 shows one set of illustrative symbols that can be used with the spiral packaging system as a form of low-vision adaptive dosage indicia.

FIGS. 24A-24C show perspective views of another embodiment of the spiral packaging system, including another form of low-vision adaptive indicia.

### DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the systems and apparatus described hereinafter may vary as to configuration and as to details. Additionally, the methods may vary as to details, order of the actions, or other variations without departing from the illustrative methods disclosed herein.

The systems, apparatus and methods described herein provide correct medications and dosages at the appropriate times. The spiral packaging is designed with clear images and names to simplify the process of determining the appropriate medications to take at the appropriate time. Additionally, the patient medication management system and method described herein eliminates the worry of taking the wrong medication at the wrong time and eliminates the need to manually open and organize prescriptions each week. Furthermore, the system and method described herein gathers all the patient's medicines together in one package and clearly show the proper dosage time.

The systems, apparatus and methods described herein provide a compliant packaging solution. Compliance packaging generally includes three aspects: firstly, an action is initiated by a patient and/or caregiver with the compliance package; secondly, the compliance package dispenses at least one tablet as a result of the action taken by the patient and/or caregiver; and thirdly, the compliance package records the dispensing of the tablet. One illustrative example of a “compliance package” is the birth control “dial pack” package, in which there are twenty-eight tablets in a blister package that are in a circular configuration (not shown). To consume the tablet, the patient pushes on the transparent plastic material and the tablet pierces a foil backing. After the tablet is dispensed from the dial package, a record is left on the dial pack package, i.e. a pressed plastic housing and pierced foil backing.

Tablet as used herein may refer to pills, gelcaps or other solid medication formed into discrete units.

The systems, apparatus and methods described herein satisfy the requirements for a compliance package because, firstly, an action is required by the patient or caregiver that requires identifying the appropriate dosage period, e.g. morning, and selecting the appropriate pouch or container. Secondly, the patient opens the appropriate container and consumes the medication. Thirdly, the patient or caregiver records the consumption of the medication by removing the container, which advances the compliance wheel or other compliance mechanism of the packaging system as described in further detail below.

The systems, apparatus and methods described herein provide assurances of the proper dosages at the proper period. Additionally, caregivers and patients get the assurance that the patient is getting the right medications and staying compliant with those medications. Furthermore, a time saving solution for dispensing tablets, medications and vitamins is described.

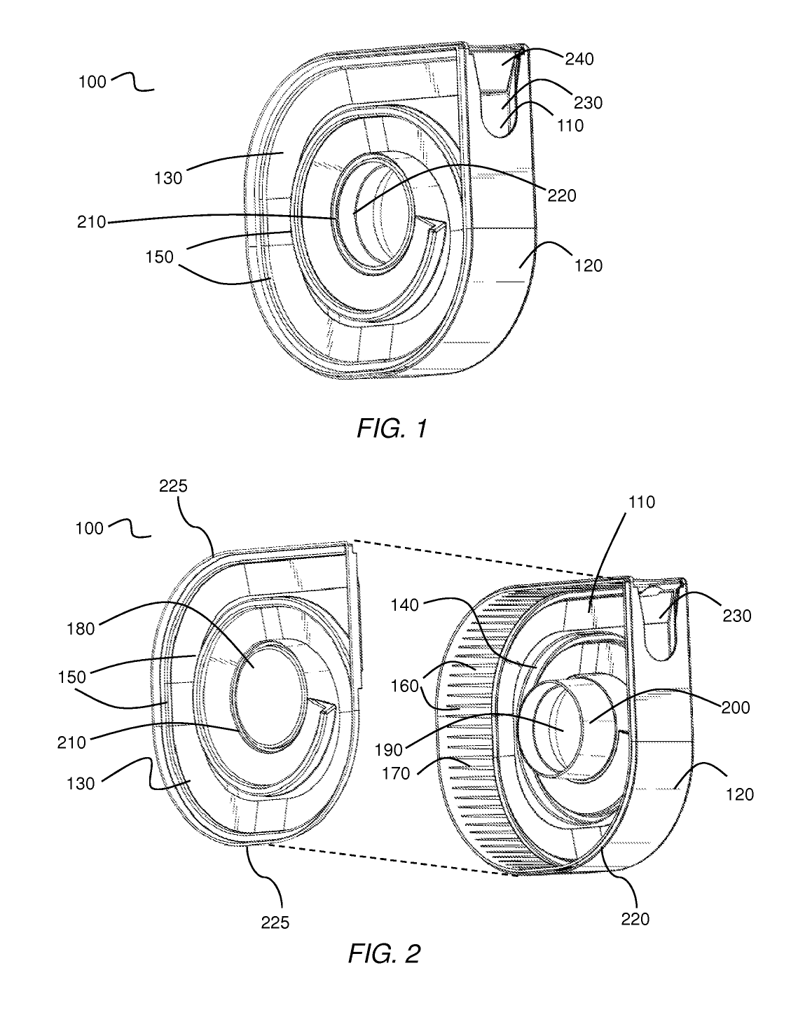

Referring now to FIGS. 1 through 3, there is shown one embodiment of a spiral packaging medication dispenser or system 100. The spiral packaging system 100 comprises first and second opposing shell portions 110, 130, and an outer wall 120. In the embodiment of FIG. 1 shell portions 110, 130 are configured to fit together with outer wall 120 circumferentially positioned about shell portions 110, 130 to define or form a medication dispenser.

The first and second shell portions 110, 130 each include a spiral track 140 and 150 respectively. Tracks 140, 150 are configured to hold a plurality of medication receptacles or containers (not shown). Grooves or ridges 160 on the interior surface 170 of wall 120 aid in positioning the pill receptacles within the spiral packaging system 100 and advancing the receptacles along the tracks 140, 150 as described further below.

The first 110 and second 130 shell portions each include a central opening 180 and 190 respectively. First shell central opening 180 and second shell opening 190 each in turn include a circular edge or flange 200, 210 respectively. Flanges 200, 210 are structured and configured to engage each other and secure first and second shell portions 110, 130 together. In the embodiment of FIGS. 1 and 2, flange 200 is of slightly larger diameter than flange 210 such that flange 210 fits within flange 200 to hold shell portions 110, 130 together. Flanges 200 and 210 may be tapered as shown in FIGS. 1 and 2 to allow flanges 200, 210 to engage each other by tension and to provide the end user with an ergonomically friendly packaging system. Outer wall 120 includes a circumferential flange 220 that engages a corresponding lip 225 on second shell portion 130. Flange 220 and lip 225 interfit and engage each other to hold second shell portion 130 to wall 120. The central openings 180 and 190 in shell components allow the apparatus 100 to be rotatably mounted on a bracket or other element as described further below.

The outer wall 120 of spiral packaging system 100 further comprises an opening or dispensing aperture 230 configured to allow medication/pill receptacles or containers (not shown) to be removed or ejected from the spiral packaging system 100. The container aperture or opening 230 is positioned on the shell wall portion 120 of the apparatus and is of sufficient size to allow medicament containers to pass through sequentially or one at a time as described further below.

First shell 110, second shell 130 and wall portion 120 of the spiral medication packaging system 100 may be manufactured from molded plastics, composite materials, engineering resins, metals or metal alloys and the like, or combinations thereof. The various components of the apparatus 100 may be made of transparent, semi-transparent or opaque materials that aid the patient or caregiver in determining the amount of pill receptacles left in the spiral packaging system 100. First shell 110, second shell 130 and shell wall 120, may be manufactured separately and configured to enable the first 110 and second 130 shell portions to snap fit together or may be joined together using adhesives or other fastening means. In certain embodiments, either the first 110 or second 130 shell portion, and the shell wall 120 section may be manufactured as integral components of a single work piece (e.g. injected molded) with the remaining shell portion configured to attach thereto to form the spiral packaging system 100 by snap fitting, tensional engagement or other fastening means.

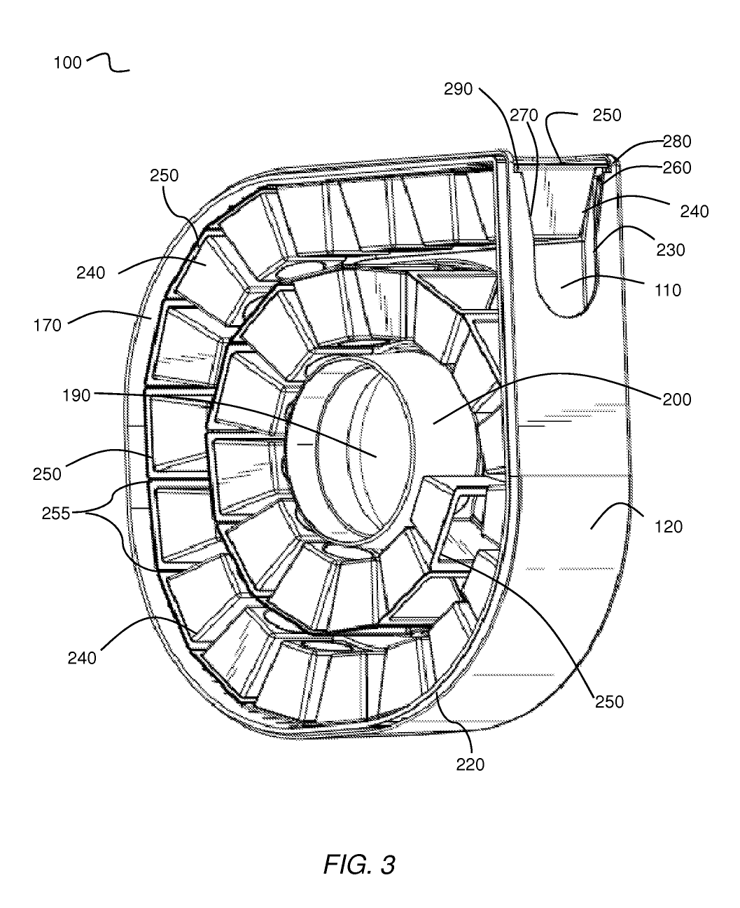

Referring also to FIG. 3, there is shown a perspective of the spiral packaging system 100 of FIGS. 1 and 2 with shell portion 130 removed to show a plurality of tablets or medicament containers 240 configured to hold tablets, caplets, pills, and other such medicaments. The containers 240 in this embodiment each comprise a flanged top edge 250 configured to fit into and interact with the interior spiral tracks 140 and 150 respectively of the first 110 and second shell 130 portions of the apparatus 100. The tubular flange 200 of the first shell central opening 190 aids in the alignment of the plurality of containers 240 within spiral tracks 140, 150. The top edge flanges 250 of adjacent containers 240 may be joined together by a frangible interface or connector 255 that is detached or broken by a user. Medicament containers 240 may be made, for example, of molded plastic or metal foil, or a combination thereof. Medicament containers as indicated at 240 may also include a frangible or removable top portion (not shown) as described below that may be penetrated or removed by user to access medication within containers 240.

The apparatus 100 in many embodiments is configured to hold approximately one month's supply that is generally a 30-day supply, but may also include 28 to 31 containers of a patient's medication. In some embodiments the spiral packaging system 100 may be configured to only hold one week of medication when the patient needs medication more than once a day. For example, when a patient will require three different medication dosages during a single day, the spiral packaging system 100 may be configured to support 21 containers (i.e. 3 doses per day×7 days=21 containers). Various other numbers of containers may be used depending upon the particular use.

Container opening 230 in wall section 120 further comprises first and second edges 260, 270 that are configured to the shape of the containers 240 to allow the containers to pass through opening 230. First 260 and second 270 edges include top indentations 280 and 290 respectively that are configured to allow the flanged edge 250 of the container 240 to pass from the interior spiral groove(s) through the container opening 230 and out of the spiral packaging system 100. The container opening 230 in many embodiments is configured to include a childproof component (not shown) as is described further below.

In certain embodiments first and second shell portions 110, 130 are reversibly attachable and detachable to allow a user to open the apparatus 100 by detaching shell portions 110, 130 so that medicament containers 240 may be inserted into the apparatus 100, after which the shell portions are re-attached. The apparatus 100 is thus re-usable as the user can replace the medicament containers 240 therein when used up. In other embodiments the medicament containers 240 may be inserted into the apparatus 100 by a health care provider or pharmaceutical supplier, with shell portions 110, 130 then being permanently attached or adhered together so that the end user or patient cannot open the apparatus 100 or access the medicament containers 240 except via the dispensing aperture 230.

To use the apparatus 100, medicament containers 240 are arranged on track 140 or 150 in a spiral arrangement to conform to the shape of tracks 140, 150, with flanges 250 of containers fitting over the outer edge of tracks 140, 150. In many embodiments, medicament containers 240 are arranged in a linear chain with each medicament container 240 joined to adjacent containers 240 by the frangible interface 255. The medicament containers 240 are positioned so that the first container 240 is adjacent to opening 230 as shown in FIG. 3. Shell portions 110, 130 are then attached to each other, leaving the medicament containers arranged along tracks 140, 150. As the patient or user accesses the first medicament container 240 through dispensing aperture 230, the user pulls the first container 240 through aperture 230, with flanges 250 on containers 240 sliding along tracks 140, 150 and over indents 280, 290 of aperture 230. Opening 230 as shown is configured to allow a user to insert a finger through opening 230 to facilitate manipulation of container 240. As the first container 240 is withdrawn from aperture 230, the remaining containers 240 are advanced along tracks 140, 150 towards aperture 230. The grooves or ridges 160 on the interior surface 170 of wall 120 provide some friction to containers 240 so that containers 240 move at a convenient rate along tracks 140, 150. When the first or end-most container 240 has exited the apparatus 100 through aperture 230, the user detaches the first container 240 by breaking frangible interface 255. The next container 240 is positioned adjacent to aperture 230 and may be accessed in the same manner. When the last medication container 240 has been withdrawn from the apparatus 100, the apparatus may be disposed of or opened to insert new medicament containers 240 and used again.

Each medicament container 240 includes, for example, the required medication for a particular time period. For each such time period, the patient accesses the container 240 adjacent to opening 230, and as each container is advanced and detached, the next container 240, having therein the medication for the next time period, is advanced to opening 230 for use in the following time period. The apparatus may include a timing element and alarm element (not shown), such as an oscillating quartz crystal timing device and a sound chip interfaced thereto, with the timing device and alarm chip powered by a small battery. When the proper time for medication has arrived according to the timing device, the alarm device may make a beeping or other alarm noise to alert the patient.

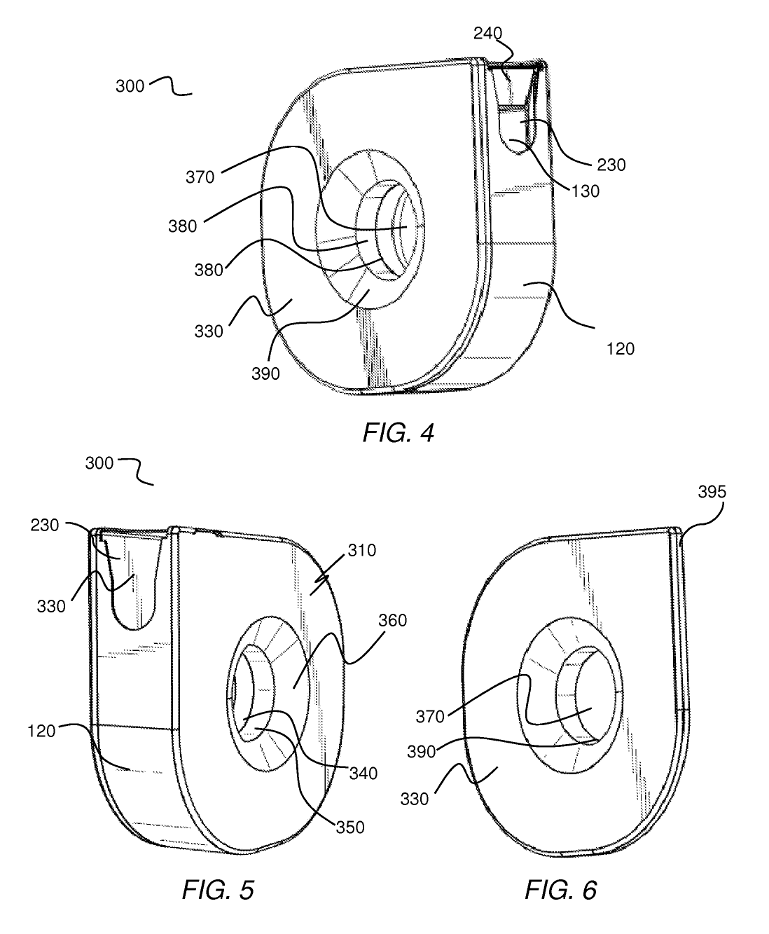

Referring now to FIGS. 4 through 6, there is shown another embodiment of a spiral medication dispenser or packaging system 300 in accordance with the invention, wherein like reference numbers are used to denote like parts. In the apparatus 300, first and second shell portions 110, 130 each include a corresponding first and second opposing facing or housing element 310, 330. Housing element 310 includes a central opening 340, a circular flange 350 surrounding opening 340, and a tapered region 360 surrounding flange 350. Housing element 330 similarly includes a central opening 370, a flange 380 surrounding the opening 370, and a tapered region 390 surrounding flange 380.

Housing elements 310, 330 are structured and configured to fit over first and second shell portions 110, 130 (FIGS. 1-3) respectively. In this regard, flanges 350, 380 are designed to fit over flanges 200, 210 of shell portions 110, 130, and tapered portions 360, 390 accommodate tracks 140, 150 of shell portions 110, 130 respectively. Housing elements 310, 330 include an outer flange 395 that is structured and configured to engage or otherwise interface with the outer lip 225 on shell portions 110, 130. Housing elements 310, 330 provide flat, smooth, easily cleanable outer surfaces to the apparatus 300 that allows facile handling and is pleasing to users. Housing elements 310, 330 facilitate inclusion of compliance and/or child proofing elements as described further below. In other respects the apparatus 300 operates and is generally used in the same manner as described above for the apparatus 100.

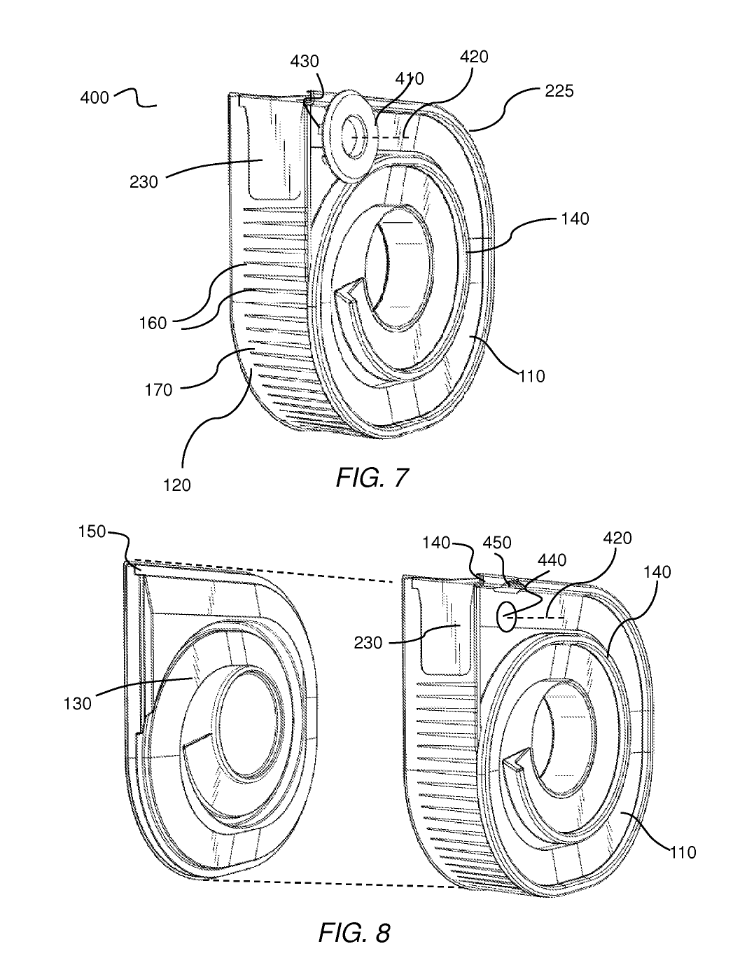

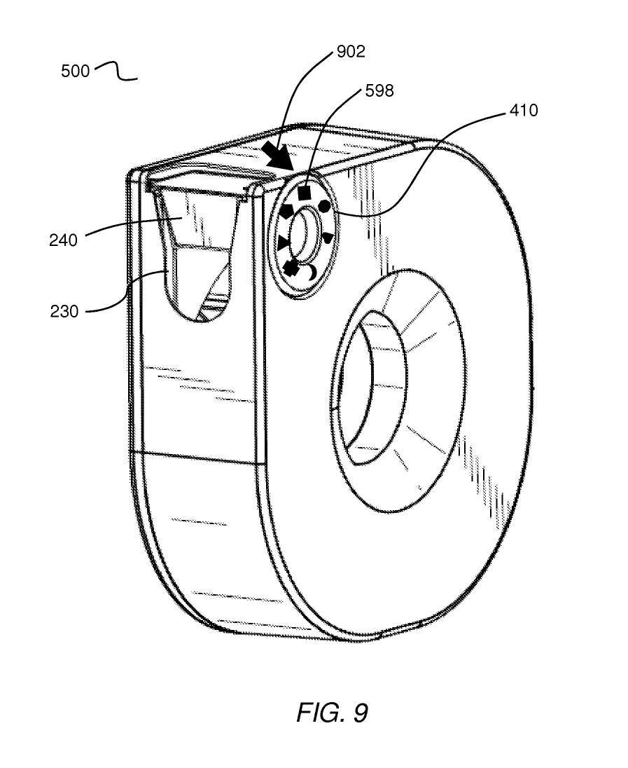

Referring now to FIG. 7, there is shown yet another embodiment of a spiral medication packaging system 400, wherein like reference numbers denote like parts. The spiral packaging system 400 shown in FIG. 7 comprises a compliance or drive wheel or sprocket 410 rotatably mounted on the first shell portion 110 of the apparatus 400 such that the compliance wheel 410 can rotate about a center axis 420. The wheel 410 includes a plurality of teeth 430 which are configured to interact with or engage containers 240 (not shown in FIG. 7 or 8) within spiral packaging system 400 when the containers 240 are adjacent or proximate to the wheel 410.

FIG. 8 is an exploded view of the spiral packaging system 400 of FIG. 7 shown with the compliance wheel 410 omitted for clarity. An opening 440 in the first shell portion 110 is structured and configured to receive and support compliance wheel 410 in a rotatable manner. A ratchet slot or opening 450 is configured to allow the teeth 430 of compliance wheel 410 access to the interior of the spiral packaging system 400, thus allowing the compliance wheel teeth 430 to interact with pill containers 240 (not shown) when the apparatus 400 is filled with a chain of containers. The ratchet opening 450 is located proximate to the end portion of spiral track 140 of first shell portion 110, and proximate to container opening 230. The user may then detach and remove the container 240 that passes through opening 230 to access the medication contained therein.

For operation of the apparatus 400, a user manually rotates compliance wheel 410. The teeth 430 of the wheel 410 fit through slot 450 and engage the container 240 (FIG. 7) adjacent to slot 450, such that interaction of teeth 430 with container 240 during rotation of wheel 410 advance container 240 towards opening 230. After container 240 passes through opening 230, the user may detach the container 240 and access the medication therein as described above. Further rotation of wheel advances the next container 240 towards opening 230.

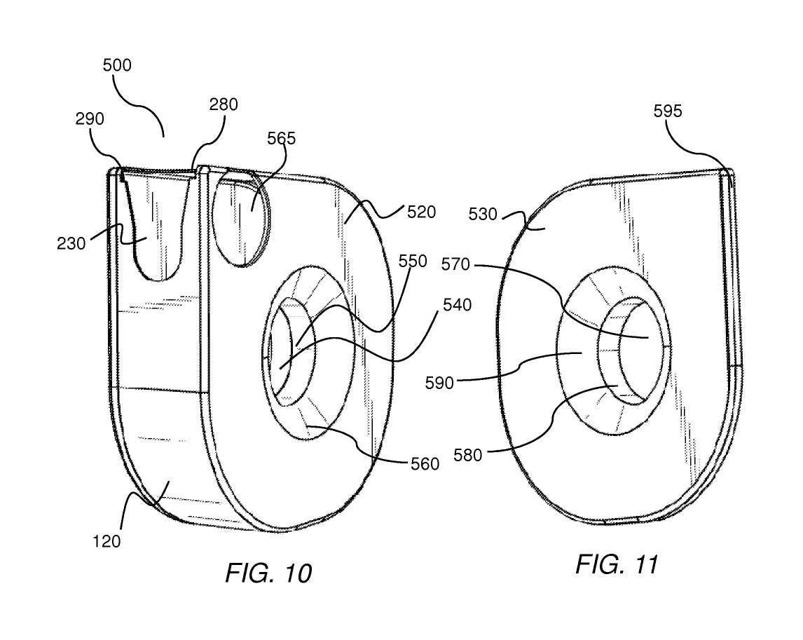

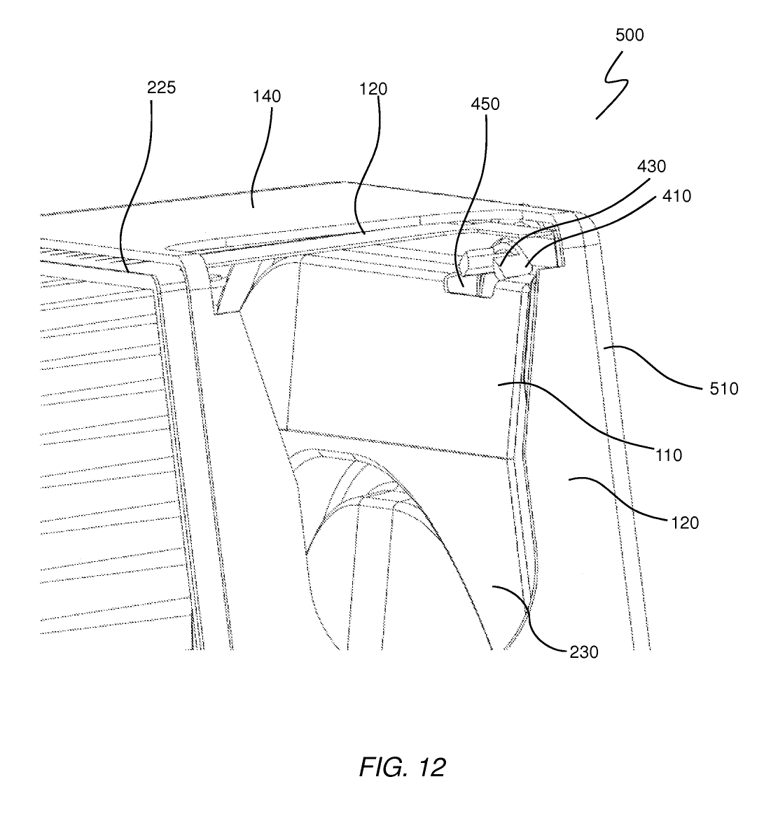

Referring now to FIGS. 9 through 12, there is shown another embodiment of a medication packaging system 500 wherein like reference numbers denote like parts. The apparatus 500 includes first and second opposing facings or housing elements 510, 530. Housing element 510 includes a central opening 540, a circular flange 550 surrounding opening 540, and a tapered region 560 surrounding flange 550. Housing element 510 also includes an opening 565 structured and configured to rotatably accommodate compliance wheel 410. Housing element 530 includes a central opening 570, a flange 580 surrounding the opening 570, and a tapered region 590 surrounding flange 580. FIG. 12 shows sprocket teeth 430 of compliance wheel 410 extending through slot 450, as viewed through opening 230 in the apparatus 500.

Housing elements 510, 530 are structured and configured to fit over first and second shell portions 110, 130 (FIGS. 7-8) respectively. Flanges 550, 580 thus are designed to fit over flanges 200, 210 of shell portions 110, 130, and tapered portions 560, 590 accommodate tracks 140, 150 of shell portions 110, 130 respectively. Housing elements 510, 530 include an outer flange 595 (FIG. 11) that is structured and configured to engage or otherwise interface with the outer lip 225 (FIGS. 7, 8) on shell portions 110, 130. As in the embodiment of FIGS. 4-6, housing elements 510, 530 provide flat, smooth, easily cleanable outer surfaces on the apparatus 300 that allows facile handling and is pleasing to users.

The compliance wheel 410 in FIG. 9 includes medical compliance indicia or indicators 598 associated with medicament containers 240, with indicia 598 configured to verify the location of medicament containers with respect to aperture 230 and to verify whether or not a medicament container has already exited aperture 230 and has been removed from the apparatus. Indicia 598 in this embodiment are temporal indicia and are shown as symbols each denoting a segment of time. For example, each symbol may indicate a day of the week (e.g., a heart for Monday, an octagon for Tuesday, a square for Wednesday, etc.) which are located circumferentially around wheel 410. The position of indicia 598 on wheel 410 correspond to the location of an associated or corresponding medicament container 240 within the apparatus 500 and provide an indication or verification for the user as to which medication container will next be dispensed through opening 230, and whether or not the medication container for a previous day or time period has already been removed from the apparatus 500.

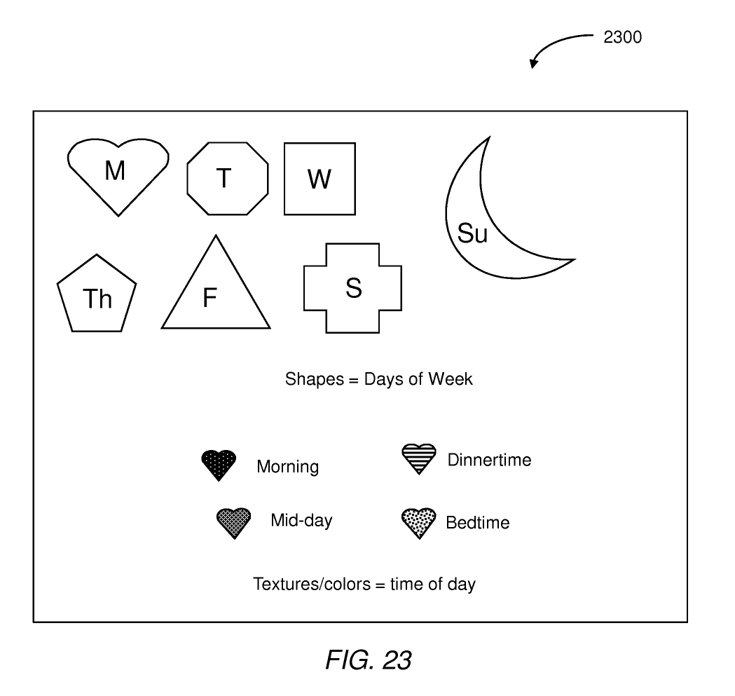

Thus, for example, when wheel 410 is rotated such that the “square” indicia 598 is adjacent to arrow 902, the user will know that the container 240 positioned in or adjacent to opening 230 includes the medication for Wednesday. The user further will know that the corresponding medication container 240 for Tuesday (represented by “octagon”) has already been removed from the apparatus 500, and that the container 240 containing Thursday (“pentagon”) medication remains in the apparatus 500 behind the container 240 having the Wednesday (“square”) medication (see FIG. 23 for the “day key”). In this manner, the user can confirm or verify whether or not the appropriate medication for each particular day or other time period has been taken. In the embodiment of FIG. 9, counter clockwise rotation of wheel 410 advances containers 240 toward the opening. In the event that a user has advanced containers 240 too far, clockwise rotation of wheel 410 may retract or move the containers back into the apparatus 500.

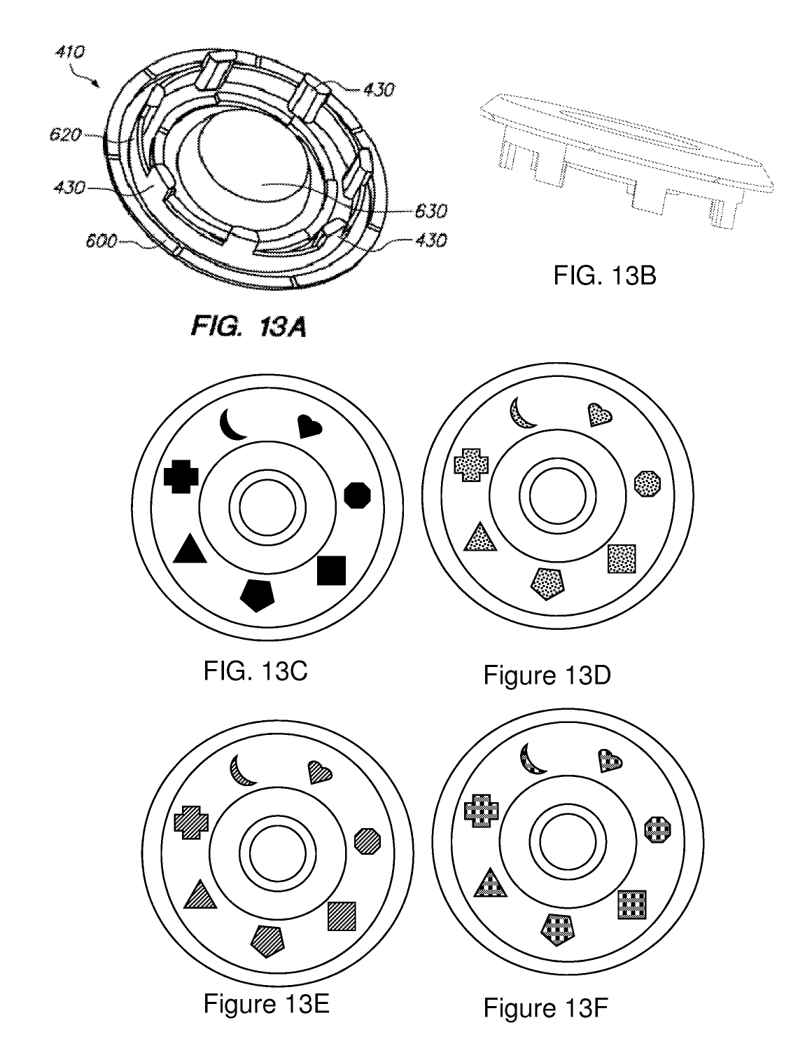

Referring to FIGS. 13A-13F, there is shown one embodiment of a compliance or drive wheel 410 in accordance with the invention. FIG. 13A shows a first or inner side 600 of a compliance wheel 410 comprising a plurality of sprocket teeth 430 configured to interact with containers held within a medication dispensing system. The number of teeth 430 elements on the compliance wheel 410 may be varied according to the type of medical compliance needed and the configuration of medicament containers. If, for example, the compliance is to be a 7 day cycle, the compliance wheel 410 comprises seven sprocket teeth 430, one for each day of the week. The teeth 430 are spaced and configured to interact with one medicament container at time.

FIG. 13C shows a second or outer side 610 of the compliance wheel which includes indicia 598 representing each day of the week. FIGS. 13D-13F show alternate textures for the indicia symbols on the compliance wheel. Each texture corresponds to a different time period, allowing those with low vision to tell the containers apart without sight. The indicia corresponding to the days of the week are aligned and configured with the sprocket teeth 430 on the compliance wheel 410 so that the user can determine if the medication for a particular day has been given, as described above. The number and positioning of sprocket teeth 430 on wheel 410 may be varied as required to accommodate different dosing requirements. The compliance wheel of the invention thus can provide for medical compliance with complex dosage regimens for patients.

The indicia 598 on compliance wheel 410 may comprise various time indicia other than, or in addition to, the days of the week as shown. For example, indicia 598 may include text, or symbols mapping to, “AM” and “PM” indicia, or “morning”, “afternoon” and “evening” indicia, or “B”, “L” and “D” for “breakfast”, “lunch” and “dinner”, depending on the particular dosing regimen needed for the patient user of the apparatus 500.

The compliance wheel 410 is shown in FIGS. 13A-13F as being structured and configured for use with the apparatus 500 of FIGS. 9-11. Wheel 410 thus comprises a circular flange 620 configured to fit within the compliance wheel opening 565 of the first side 510 of the housing of the spiral packaging system 500 shown in FIG. 9. Sprocket teeth 430 are positioned on flange 620. Wheel 410 further comprises a central indented portion 630 configured to facilitate manual rotation of wheel 410 by a user.

While the compliance wheel 410 is shown as being configured for manual operation, various other mechanisms for turning or advancing compliance wheel 410 may be used. For example, a spring-actuated mechanism operating according to force applied to a button, or a small battery-driven electric motor may be used to rotate wheel 410.

The compliance wheel 410 may be used with various medical packaging systems other then the spiral packaging system disclosed herein. Any pill packaging system comprising a plurality of containers 240 arranged in a chain can utilize a compliance wheel to aid the user in determining when the last dosage was given and when the next dosage is needed, as well as to move or advance medication containers within a dispensing device. For example, a rectangular box comprising seven medicament containers 240, i.e. a weekly dose, could be used with the compliance wheel to determine if the current day's dosage had been given. The medicament containers 240 could be arranged in a linear, circular or snake-like alternating chain configuration. Use of a compliance wheel in accordance with the invention this provides for a variety of medication packaging systems with a dosage compliance feature.

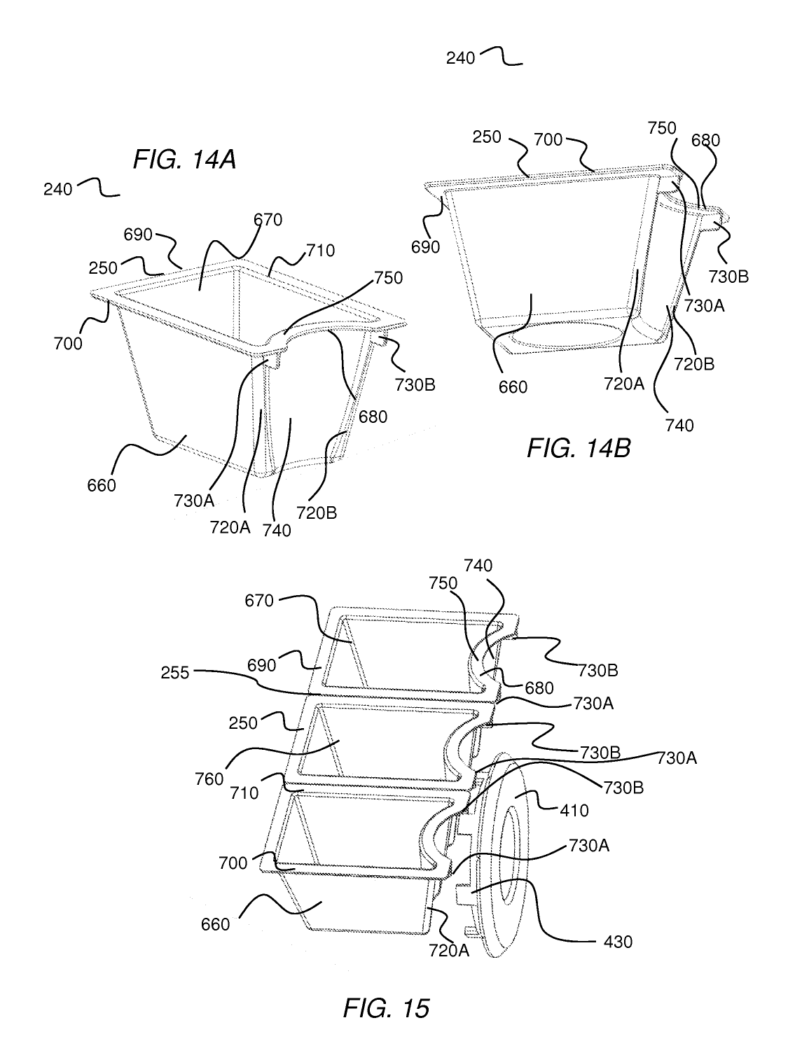

FIG. 14A, FIG. 14B and FIG. 15 show one embodiment of a medicament container or cup 240 for holding medication in the form of tablets, caplets, pills, capsules, powders, liquids, gels, suppositories or other form of medication. The medication within containers 240 may be prescription medication, vitamins, supplements, herbal formulations, or combinations thereof, intended to be ingested by or administered to a patient to improve the patient's health or well being. The medicament container 240 comprises a tapered body 660 with a cavity 670 for holding a plurality of pills or other medication. The container 240 includes a flanged top surface or edge 250 configured to be sealed with a lid (not shown). Container 240 may also include a frangible or removable top or lid (not shown) adjacent to flange 250. Breaking or removing the top allows a user to access the medication therein. The top may be transparent to allow a user to see the contents of container 240.

Generally, the flanged top edge 250 of container 240 comprises a first side 680 and second 690 side which are configured such that flange 250 interacts with the spiral grooves or tracks 140, 150 (FIGS. 1 and 2) of a packaging system such that container 240 can slide or otherwise move along tracks 140, 150. The flange top edge 250 further comprises a third side 700 and fourth side 710. When containers 240 are arranged in a chain, side 700 of one container 240 is positioned adjacent to side 710 of an adjacent container (except for the first container 240 in the chain). Top edge sides 700 and 710 of adjacent containers 240 can be connected to one another by a frangible interface 255. The containers 240 can then be detached from one another by breaking the connector 255.

Each container 240 includes protrusions or ribs 720A, 720B on the exterior of tapered body 660 of the container 240. Ribs 720A and 720B each support a tab section 730A and 730B respectively, with tabs 730A, 730B located adjacent top flange 250. The tabs 730A and 730B are configured to interact with sprocket teeth 430 (FIG. 14) on compliance wheel 410 to allow the container 240 to be moved as teeth 430 apply force to tabs 730A, 730B when wheel 410 is rotated. The ribs 720A and 720B and tabs 730A and 730B may in many embodiments be configured to aid in childproofing the packaging system, as described further below. Counter-clockwise rotation of wheel 410 results in teeth 430 applying force to tab 720A to move container 240 in one direction, while clockwise rotation of wheel 410 results in teeth 430 applying force to tab 720AB to move container 240 in the opposite direction.

The tapered body 660 of each container 240 further comprises an arcuate or concave portion 740 positioned between the ribs 720A and 720B. Top flange 250 includes an arcuate or concave portion adjacent to the concave portion 740 of container body 660. The configuration of the concave portions 740 and 750 of the container 240 allows the teeth 430 of compliance wheel 410 to engage the tab portions 730A, 730B of the container 240 without interference from the tapered body 660 of the container 240.

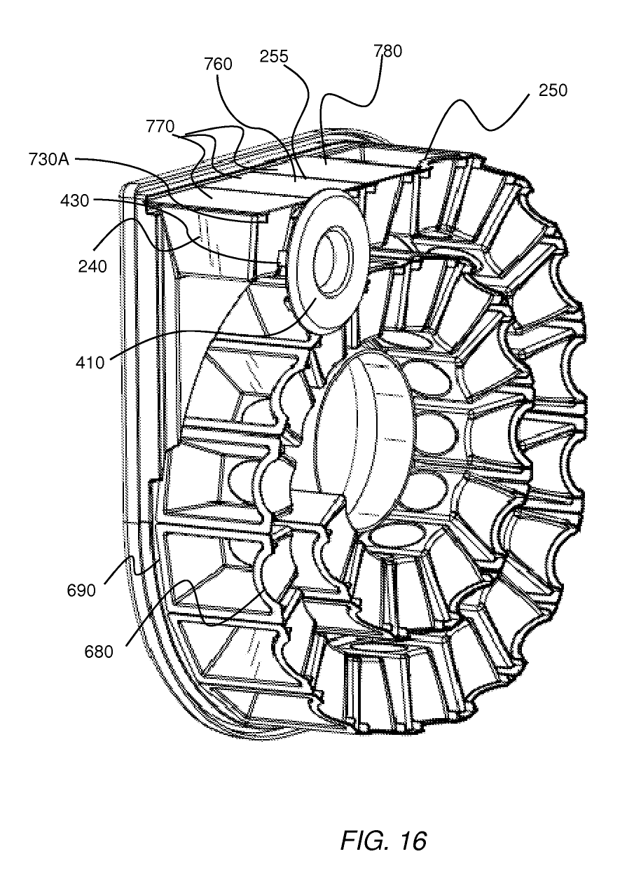

Referring now to FIG. 16, a plurality of medication containers 240 and a compliance wheel 410 are shown in association with the spiral track of shell portion 130 of a spiral packaging system (wall 120 and shell portion 110 are omitted for clarity). A flexible lidstock strip 760 provides a cover for the chain of containers 240, with the portion of lidstock strip 760 adjacent to a container providing a lid or cover 770 for that container. For clarity, lidstock strip 760 is shown only on the first three containers 240, but it should be understood that lidstock strip 760 extends to cover each of the containers in FIG. 16. The top edge sides 700 and 710 of adjacent containers 240 are joined together by the lidstock strip 760, which seals each container 240 and joins adjacent containers 240 together.

The lidstock strip 760 may be frangible or breakable at the interface or junction of sides 700, 710 to allow detachment and separation of adjacent containers 240. The lidstock strip 760 may include perforation lines (not shown at edges 700 and 710) to provide frangible interfaces 255. When thus detached, each container 240 retains a portion 770 of the lidstock strip 760 as a cover, which can be removed or broken to access the medication within the container 240.

A plurality of containers 240 may be connected to one another by a single lidstock strip 760, allowing a “chain” of containers to be easily filled, sealed and placed in the spiral groove or track of a packaging system. Each sealed container 240 may be assigned to a specific dosage period and contain the medicines required for that dosage period. The section of lidstock strip 760 adjacent to each container 240 may be printed (using thermal transfer, ink jet, laser, or other suitable electronic printing method) with patient, medicine, and dosage period information, such as patient name; D.O.B.; dosage period; date; medicine contained including type, strength, number of tablets; expiry date, and the like.

Lidstock strip 760 provides a writing surface 780 where patient data, container content and prescription information can be placed. The lidstock strip 760 may be extended between adjacent sealed containers (and then folded up as it is loaded into the dispenser or packaging system) to allow for extra writing surface print area and a larger gripping surface for removing lids 770 from containers 240. The sealed container strip or chain is designed to be filled using a valid table automated filling system that can include automatic inspection and verification of the medication product with which containers 240 are filled.

The lidstock strip 760 is configured to attach or adhere to the flanged top surface 250 of each of the individual containers 240. Lidstock strip 760 is preferably a laminated film which is heat sealed onto the flanged tops 250 of containers 240. Lidstock strip 760 may further comprise peel tabs (not shown) which extend out past the flanged top edge 250, making the lid 770 of each container 240 removable by peeling to facilitate in the opening of the container 240. Concave portions 740 and 750 facilitate removal of lid 770 from container 240 by a user by providing a “finger groove” to allow grasping of the lid 770 (it may also include a separable plastic gripping tab and/or a feature to enable it to be connected to the dispenser body for one-handed opening). Lid 770 also comprises a writing surface 780 where patient data, container content and prescription information can be placed.

The individual containers 240 are preferably manufactured from clear or tinted plastic to allow viewing of the tablets within. The individual container(s) may be made by thermoforming or injection molding techniques. Exemplary plastics utilized for the individual container comprise but are not limited to polyphenysulphone, polystyrene, polypropylene, as well as polyethylene. The lidstock strip may comprise a paper-backed plastic film or foil laminate with sealing material in the structure for a peel seal with the molded plastic sealed flanged cup body.

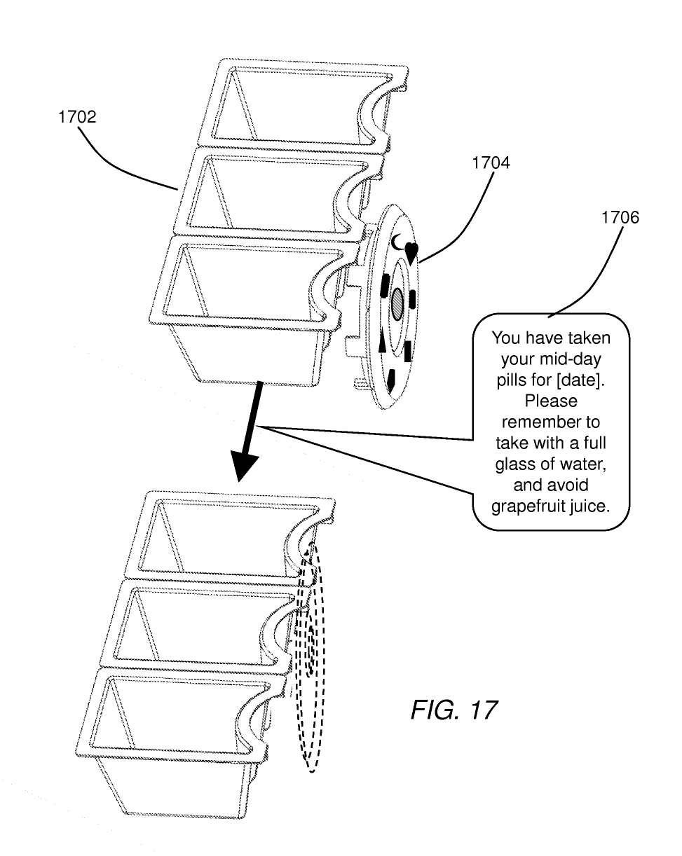

Referring now to FIG. 17, there is shown a partial strip of medicament cups 1702 in articulation with the compliance wheel. In this embodiment, actuation of the compliance wheel 1704 will activate audio compliance indicia (e.g. message 1706). The audio associated with the compliance wheel may be actuated by rotating the compliance wheel counter-clockwise (advancing the wheel) or by rotating the wheel counter-clockwise. In some embodiments, the audio associated with the compliance wheel may be activated by activating a switch, for example, by depressing the compliance wheel relative to the apparatus. In yet another embodiment, the audio may be activated when a container is removed from the dispenser. The audio may be initiated mechanically in response to the movement of the teeth on the compliance wheel. The audio compliance indicia may include dosage information, precaution information, or a combination thereof. For example, when the compliance wheel is advanced, an audio message may be initiated, such as, “You have taken your mid-day pills for [date]. Please remember to take with a full glass of water, and avoid grapefruit juice.”

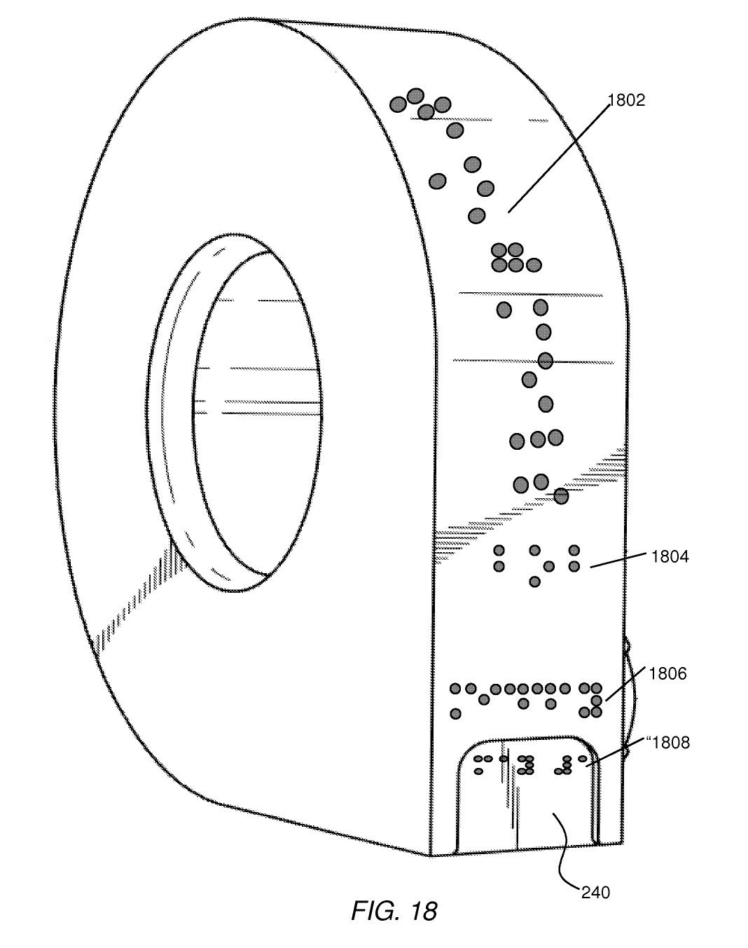

Referring now to FIG. 18, there is shown another embodiment of a spiral packaging system in accordance with the invention. The apparatus includes transparent outer facings or housing elements that are joined to shell portions as described above for the apparatus in FIGS. 4-6. In this illustrative embodiment, compliance indicia, including precautions, the name of the patient, the time period for tablet consumption, and the date are included in Braille. For example, apparatus may have Braille indicia such as the messages shown in FIG. 18, in which Braille messages 1802, 1804 and 1806 indicate, “Take with meals,” a patient name “Bob,” a tablet consumption time “Mid-Day,” respectively. Additionally, container 240 is marked with a Braille indication 1808 of the date the tablets within the container are to be consumed. This type of package is suitable for individuals who have become fluent in Braille. However, Braille indicia may not work for the many patients who are blind or have low vision, but have not learned Braille.

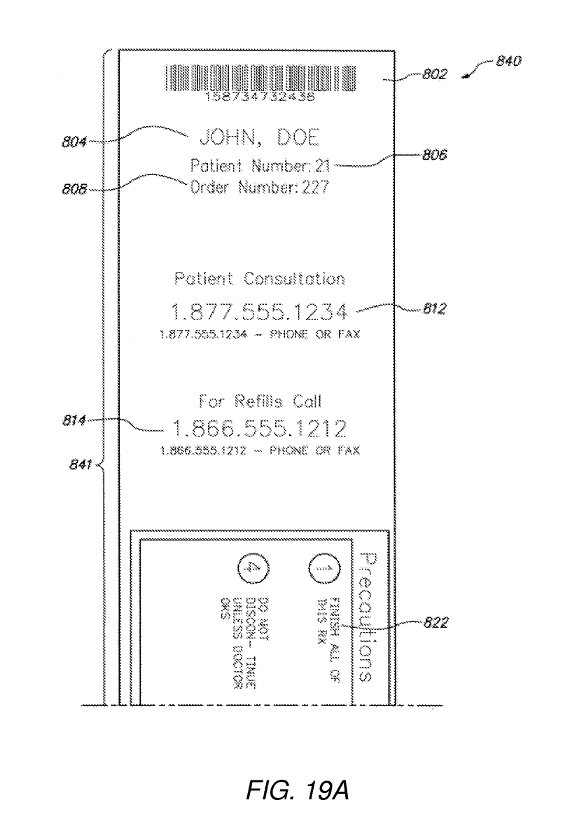

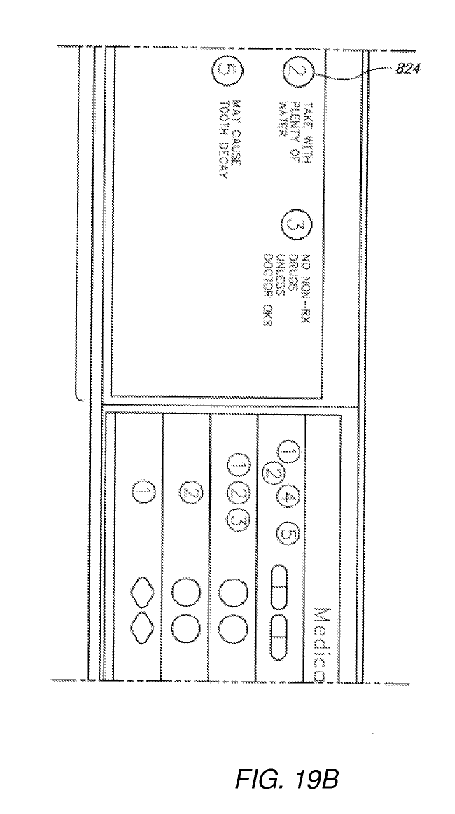

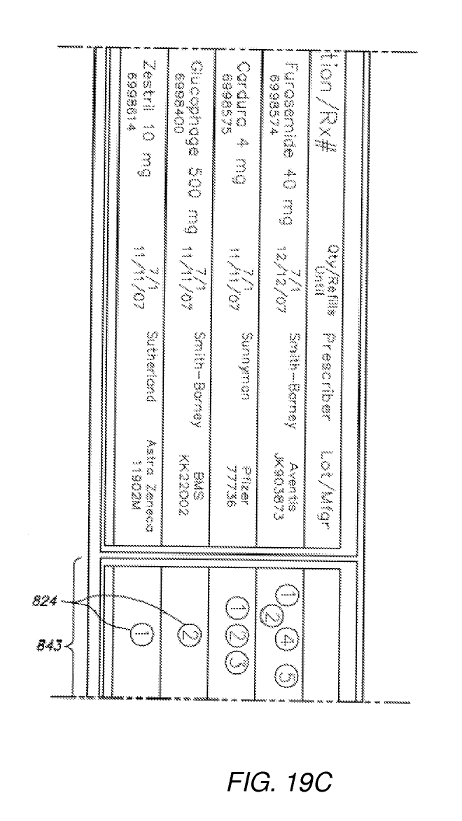

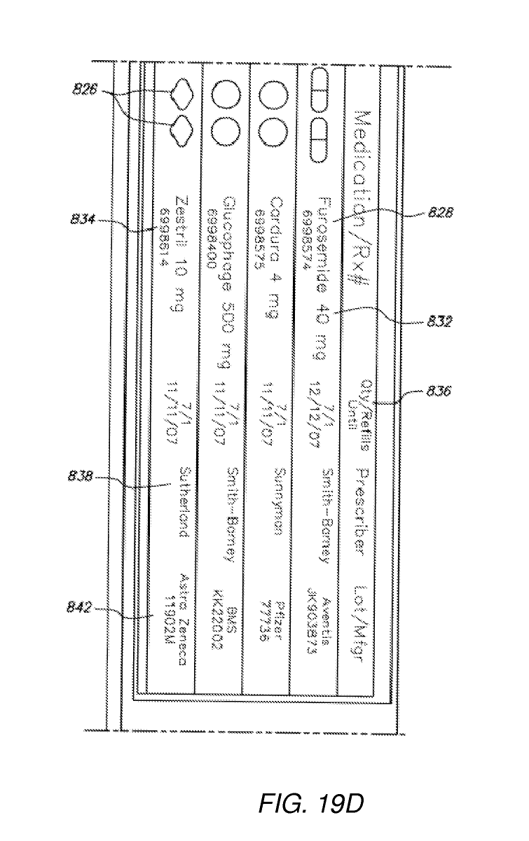

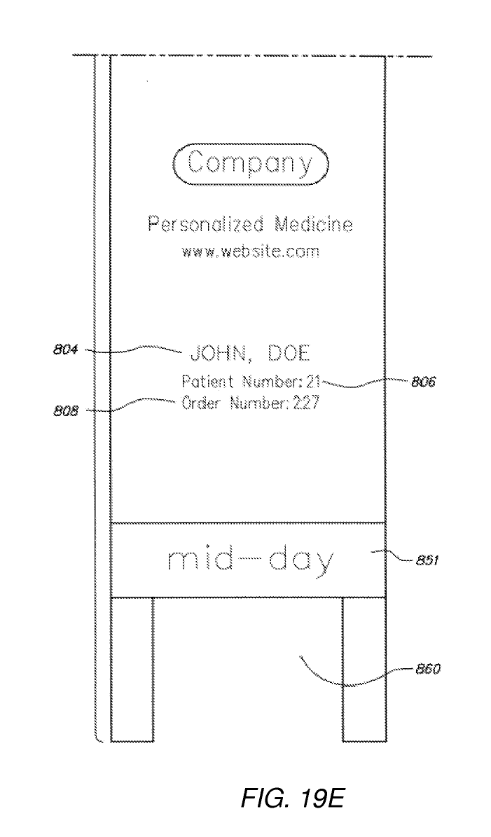

Referring to FIGS. 19A-E, a label strip 840 is structure and configured to fit within the apparatus 800 along the transparent outer wall 120. Label strip 840 includes indicia 850 that include patient and medication data such as, for example, patient name and number, names of relevant physicians, medicine(s), dosage strength(s), medicine quantity(s), color images of the medicine(s), prescription number(s), NDA number(s), warning(s), dosage period(s), administration schedule(s), and the like. In embodiments wherein the apparatus 800 is reusable, label strip 840 may be interchangeable and removable from the apparatus 800 when disassembled. In embodiments where the apparatus 800 is disposable after each use, the label strip 840 may be adhered directly to the inner or outer surface of wall 120. An opening 860 at the end of strip 840 conforms in shape to opening 230 so that opening 230 is not blocked by strip 840. While this detailed label includes much useful information for the sighted, it is of little use to a patient who is blind or has low vision. It is desirable to include as much information as possible from the label for sighted individuals in the low-vision adaptive indicia.

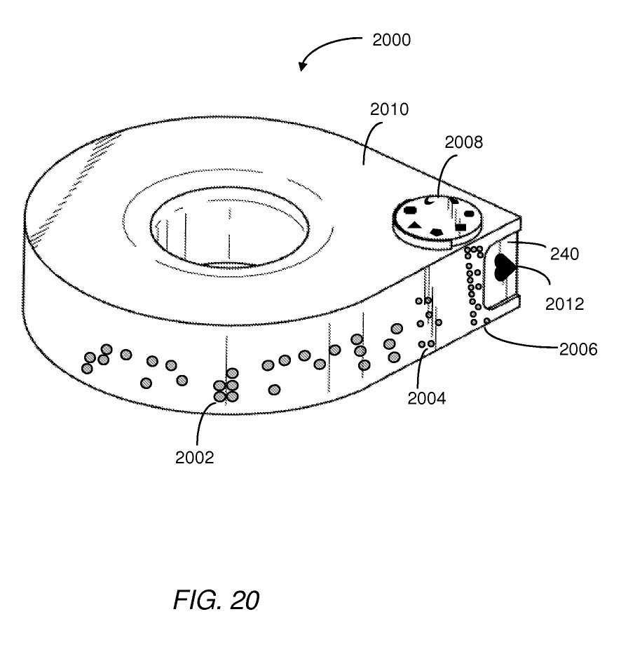

Referring now to FIG. 20, another embodiment of a low-vision adaptive spiral package is shown. This embodiment 2000 shows one combination of Braille indicia and an alternate audio compliance actuator. Braille text 2002 reads “Take with Meals.” This phrase corresponds to a drug precaution that can be associated with a particular tablet in a multiple medication regimen. Braille text 2004 is the name of the patient, in this case, it reads “Bob.” Note, the patient's full name does not need to appear in Braille. Braille text 2006 refers to the particular time period that the tablets are supposed to be consumed, in this case, “Mid-day.” The container may additionally have Braille or symbolic indicia of the time period associated with the tablets contained and additional precautionary information associated with the tablets. The audio compliance indicator is actuated when compliance wheel 2008 is depressed relative to dispenser 2010. Symbol 2012 located on container 240 is an illustrative compliance indicator providing an indication to the patient of, for example, the day of the week on which the tablets within the container are to be consumed.

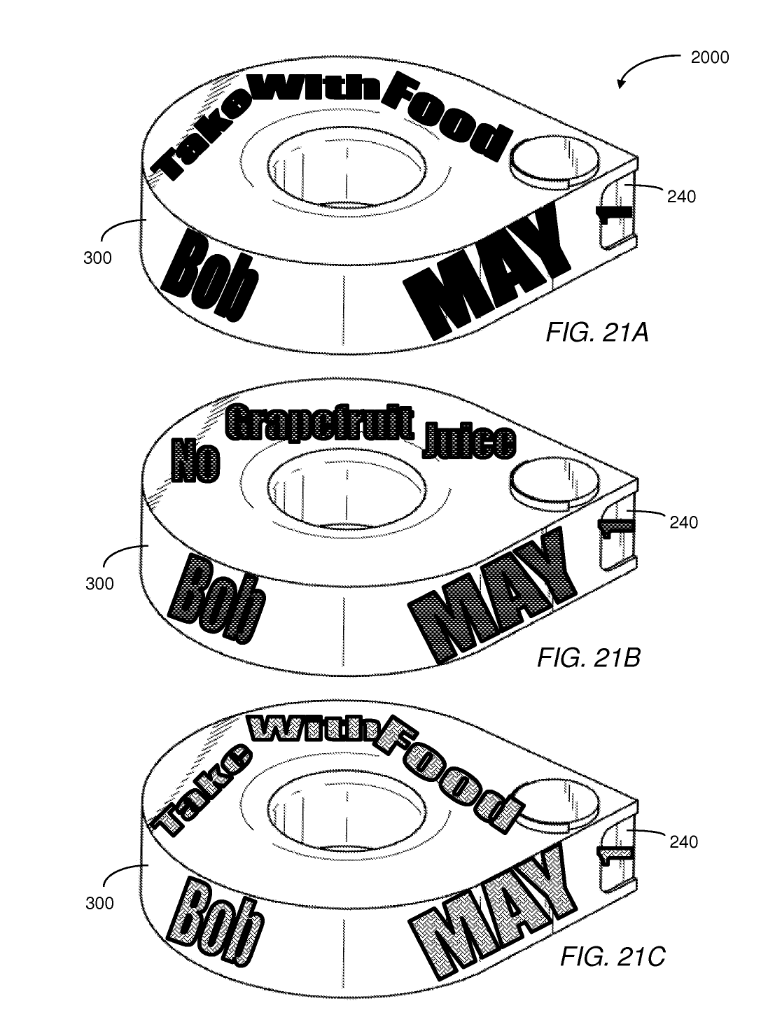

Referring now to FIGS. 21A-21C, there is shown a set of low-vision adapted spiral medication packages. In the exemplary embodiment shown, the packages indicated at 21A, 21B and 21C contain tablets to be consumed in the morning, at noon, and in the evening, respectively. In this embodiment, the precautions appear in enlarged text that is configured to be used by those with low vision. The enlarged text on dispensers 230 and containers 240 is shown with a variety of fill patterns which may represent a variety of colors. The illustrative colors represented by the fill patterns are red, represented by the solid fill in FIG. 21A; orange, represented by the crosshatched fill in FIG. 21B; and yellow, represented by the tiled fill in FIG. 21C. Enlarged text The different fill patterns may also represent textures. The illustrative textures are represented by the solid fill in FIG. 21A, the crosshatched fill in FIG. 21B; and the tiled fill in FIG. 21C. In the preferred embodiment, the textures and colors are paired such that each time period is represented by both a color and a texture, giving those with low vision more than one cue to use to interpret the text.

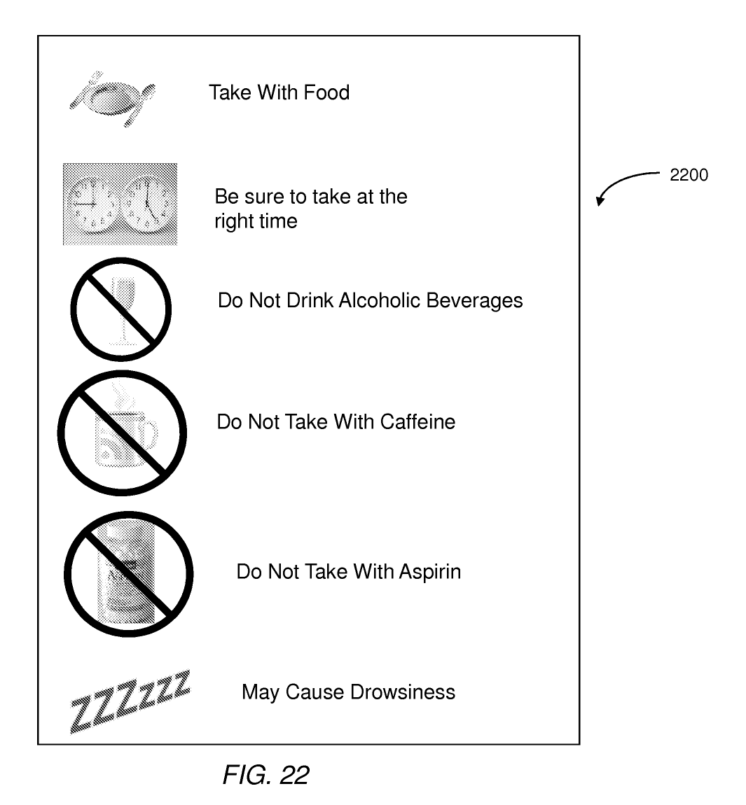

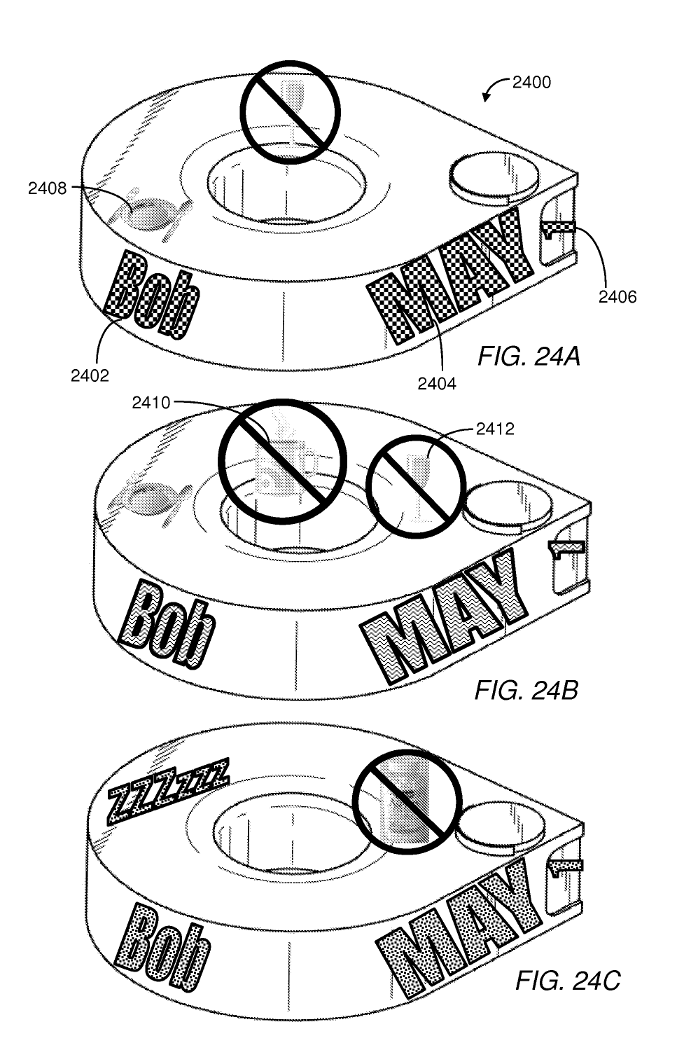

Referring now to FIG. 22, there is shown in legend 2200 an illustrative list of symbols that may be used to convey drug precaution information to those with low vision. The symbols shown in FIG. 22 may appear on the medication dispensers as shown at FIGS. 24A-24C.

Referring now to FIG. 23, there is shown in legend 2300 an illustrative list of symbols that may be used to convey the day of the week and the time that the tablets should be taken to those with low vision. The symbols shown in FIG. 22 may appear on the medication dispenser, compliance wheel, or tablet container.

Referring now to FIGS. 24A-24C, there is shown a set of low-vision adapted spiral medication packages 2400. In this embodiment, the name of the patient 2402, the month that the tablets should be taken 2404, and the day of the month that the tablets should be taken 2406 all appear in enlarged text that is configured to be used by those with low vision. The different fill patterns represent colors. The illustrative colors represented by the fill patterns are red, represented by the solid fill in FIG. 21A; orange, represented by the crosshatched fill in FIG. 21B; and yellow, represented by the tiled fill in FIG. 21C. The precautions information is denoted by symbols (see FIG. 22) that are configured to be used by those with low vision. The illustrative symbol 2408 that resembles a dinner plate means to take the medication with food. Illustrative symbol 2410 indicates that the medication should not be taken with caffeine, and illustrative symbol 2412 indicates that the medication should not be taken with alcohol.

It is to be understood that the foregoing is a detailed description of illustrative embodiments. The scope of the claims is not limited to these specific embodiments or examples. Therefore, various elements, details, execution of any methods, and uses can differ from those just described, or be expanded on or implemented using technologies not yet commercially viable, and yet still be within the inventive concepts of the present disclosure. The scope of the invention is determined by the following claims and their legal equivalents.

1. A compliance packaging system for dispensing tablets to the vision impaired, comprising:
a dispenser having a plurality of tablet containers wherein each of the tablet containers contains at least one tablet associated with a dosage regimen;
compliance indicia associated with the plurality of tablet containers, the compliance indicia configured to verify that a particular tablet container has exited the dispenser.

2. The compliance packaging system of claim 1, wherein a compliance indicator is marked on each tablet container.

3. The compliance packaging system of claim 1, wherein the compliance indicia comprise a set of symbols, each symbol indicating a segment of time.

4. The compliance packaging system of claim 1, wherein the compliance indicia comprise a set of symbols each having a unique texture.

5. The compliance packaging system of claim 1, wherein the compliance indicia comprise an audio message initiated when a tablet container has exited the dispenser.

6. The compliance packaging system of claim 1, wherein the compliance indicia comprise a Braille message.

7. The compliance packaging system of claim 1, wherein the compliance indicia comprise an enlarged text message.

8. The compliance packaging system of claim 7, wherein the enlarged text message belongs to a set of enlarged text messages, each message having a color indicating a segment of time.

9. The compliance packaging system of claim 7, wherein the enlarged text message belongs to a set of enlarged text messages, each message having a texture indicating a segment of time.

10. The compliance packaging system of claim 1, wherein the dispenser is marked with an enlarged text message indicating information associated with one or more tablets within the dispenser.

11. A compliance packaging system for dispensing tablets to the vision impaired, comprising:
a dispenser having a plurality of tablet containers wherein each of the tablet containers contains at least one tablet associated with a dosage regimen, the dispenser including an aperture configured to allow the tablet containers to exit the dispenser through the aperture;
a drive element mounted on the dispenser, the drive element configured to advance the tablet containers toward the aperture;
compliance indicia, wherein each of the compliance indicia is associated with a tablet container, the compliance indicia configured to verify that a particular tablet container has exited the dispenser through the aperature.

12. The compliance packaging system of claim 11, wherein the compliance indicia are located on the drive element.

13. The compliance packaging system of claim 11, wherein the compliance indicia comprise a set of symbols, each symbol indicating a segment of time.

14. The compliance packaging system of claim 11, wherein the compliance indicia comprise a set of symbols each having a unique texture.

15. The compliance packaging system of claim 11, wherein the compliance indicia comprise an audio message initiated when the drive element is advanced.

16. The compliance packaging system of claim 11, wherein the compliance indicia comprise a Braille message.

17. The compliance packaging system of claim 11, wherein the compliance indicia comprise an enlarged text message.

18. The compliance packaging system of claim 17, wherein the enlarged text message belongs to a set of enlarged text messages, each message having a color indicating a segment of time.

19. The compliance packaging system of claim 17, wherein the enlarged text message belongs to a set of enlarged text messages, each message having a texture indicating a segment of time.

20. A method for dispensing tablets to the vision impaired with a compliance packaging system, the method comprising:
housing a plurality of tablet containers in a dispenser, in which each of the tablet containers contains at least one tablet associated with a dosage regimen;
actuating a drive element to advance the tablet containers such that the tablet containers exit the dispenser;
indicating with a compliance indicator that a particular tablet container has exited the dispenser.

21. The method of claim 20, further comprising initiating an audio message when the drive element is advanced.

22. The method of claim 20, further comprising initiating an audio message when a switch coupled to the dispenser is activated.

23. The method of claim 20, wherein the compliance indicator is a symbol marked on the drive element, such that compliance is indicated when the drive element is advanced.

24. The method of claim 20, wherein the compliance indicator is a symbol marked on the tablet container and visible on an undispensed tablet container located within the dispenser, such that compliance is indicated when a tablet container is removed from the dispenser.
